(19) United States
(12) Patent Application Publication
(10) Pub. No.: US 2026/0299793 A1
(43) Pub. Date: Oct. 1, 2026

(54) RUN TIME PATTERN RECOMMENDATION IN A STORAGE SYSTEM

(71) Applicant: Sandisk Technologies, Inc., Milpitas, CA (US)

(72) Inventors: DHARMARAJU MARENAHALLY KRISHNA, Bangalore (IN); RAMANATHAN MUTHIAH, Bangalore (IN); SUNDAR PRASAD, Bangalore (IN); DURGA PRAVEEN MADDINENI, Bangalore (IN); JUDAH GAMLIEL HAHN, Bangalore (IN)

(73) Assignee: Sandisk Technologies, Inc., Milpitas, CA (US)

(21) Appl. No.: 19/089,245

(22) Filed: Mar. 25, 2025

(51) Int. Cl. G06F 3/06

(52) U.S. Cl. CPC G06F 3/0619; G06F 3/0653; G06F 3/0659; G06F 3/0679

(57) ABSTRACT

A storage device may provide run-time recommendations to a host for the host to modify host data streams being sent to the storage device to improve performance on the storage device. The storage device includes a memory device to store host data sent from the host to the storage device. A controller on the storage device may receive a host data stream and analyze the host data stream. The controller may identify a first performance benchmark value associated with the host data stream. The controller may also evaluate a possible host data pattern and calculate a second performance benchmark value for the possible host data pattern. The controller may provide the first performance benchmark value and/or the second performance benchmark value to the host.

### BACKGROUND OF THE INVENTION

A storage device may be communicatively coupled to a host and to non-volatile memory including, for example, a NAND flash memory device on which the storage device may store data received from the host. The memory device may include memory cells that may be used to store data sent from the host to the storage device and the memory device may be designed to accommodate a finite number of write/erase cycles before the memory cells become unreliable. The storage device may be designed to meet certain benchmarks for, for example, endurance, write amplification factor (WAF), and sustained performance. The endurance benchmark may identify the total amount of data that may be written to the storage device before the storage device starts to degrade due to wear and tear on the memory cells. The write amplification factor may identify how much more data the storage device needs to physically write to the memory device compared to the amount of data the host initially sent to be written to the memory device. The sustained performance of the storage device may identify the consistent average speed during normal usage at which the storage device may transfer data over a prolonged period, rather than a peak burst speed over a short period.

The same storage device may be used by different types of hosts. For example, the same storage device may be used in a security system, a surveillance system, or a medical system The host data patterns of random data and/or sequential data received on the storage device may depend on the types of applications being executed on the host. Depending on the characteristics of the memory device and/or host data patterns (i.e., the patterns of random and/or sequential host data received on the storage device), performance of the storage device may vary. For example, the write application factor or other performance benchmarks when the storage device is used in a security system may be better than the performance benchmarks when the storage device is used in a medical system.

When the storage device does not meet a performance benchmark, for example, its WAF benchmark, the host customers may contact the storage device vendor to address performance issues. Typically, the storage device vendor may analyze the host data pattern(s) and corresponding WAF and statically estimate the life of the storage device against the host data pattern(s). In some cases, the storage device vendor may customize firmware on the storage device for the storage device to meet its benchmark for a given application or use case. In other cases, the storage device vendor may recommend other host data patterns, scenarios, and/or use cases to the host customer. The host customer may have to update the host application to accommodate the updated firmware and/or recommendations. The process of customizing the storage device and/or providing recommendations for specific host applications may be costly in time and resources and possibly lead to the host customer using a storage device provided by a different vendor.

### SUMMARY OF THE INVENTION

In some implementations, a storage device may provide run-time recommendations to a host for the host to modify host data streams being sent to the storage device to improve performance on the storage device. The storage device includes a memory device to store host data sent from the host to the storage device. A controller on the storage device may receive a host data stream and analyze the host data stream. The controller may identify a first performance benchmark value associated with the host data stream. The controller may also evaluate a possible host data pattern and calculate a second performance benchmark value for the possible host data pattern. The controller may provide the first performance benchmark value and/or the second performance benchmark value to the host.

In some implementations, a method is provided on the storage device for providing run-time recommendations to a host for the host to modify host data streams being sent to the storage device to improve performance on the storage device. The method includes receiving a host data stream. The method also includes analyzing the host data stream and identifying a first performance benchmark value that is associated with the host data stream. The method further includes evaluating a possible host data pattern and calculating a second performance benchmark value for the possible host data pattern. The method also includes providing the first performance benchmark value and/or the second performance benchmark value to the host.

In some implementations, a storage device may provide run-time recommendations to multiple hosts for the hosts to modify host data streams being sent to the storage device to improve performance on the storage device. The storage device includes a memory device to store host data sent from the host to the storage device. A controller on the storage device may receive a first host data stream from a first host and a second host data stream from a second host. The controller may analyze the first host data stream and identify a first performance benchmark value that is associated with the first host data stream and analyze the second host data stream and identify a second performance benchmark value that is associated with the second host data stream. The controller may evaluate a first possible host data pattern for the first host and determine a first benchmark value for the first possible host data and evaluate a second possible host data pattern for the second host and determine a second benchmark value for the second possible host data. The controller may determine when the first benchmark value and/or the second benchmark value is greater than a threshold and provide an indication to the first host and/or the second host with the benchmark value that is greater than the threshold.

### BRIEF DESCRIPTION OF THE DRAWINGS

FIG. 1 is a schematic block diagram of an example system in accordance with some implementations.

FIG. 2 is another block diagram of an example system in accordance with some implementations.

FIG. 3 is an example benchmark table used in accordance with some implementations.

FIG. 4 is an example flow diagram for providing run time recommendations for host data streams in accordance with some implementations.

FIG. 5 is a diagram of an example environment in which systems and/or methods described herein are implemented.

FIG. 6 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

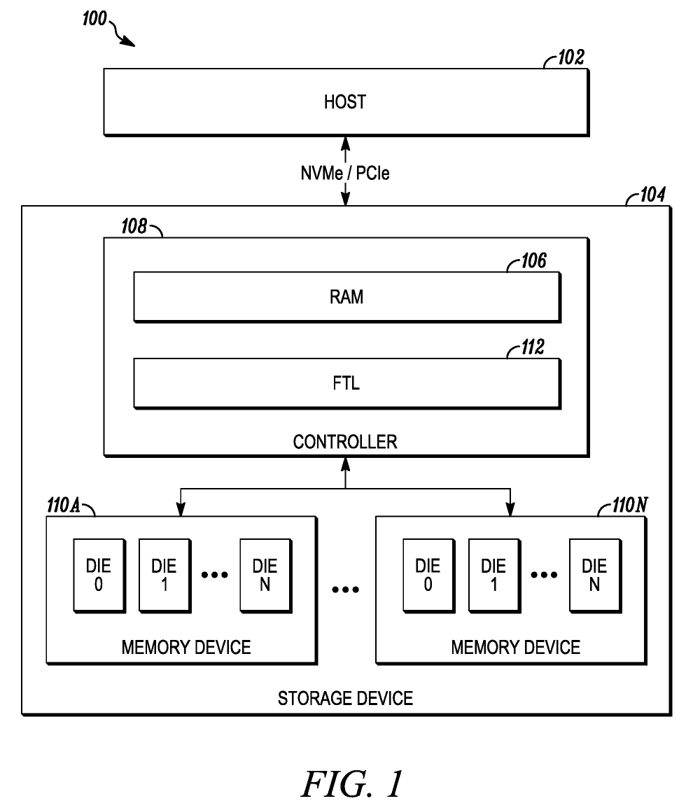

FIG. 1 is a schematic block diagram of an example system in accordance with some implementations. System 100 may include a host 102 and a storage device 104 that may be in the same physical location as components on a single computing device or on different computing devices that are communicatively coupled. Host 102 may provide operational power for storage device 104. Storage device 104 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage device 104 may be, for example, a solid-state drive (SSD) that may include a random-access memory (RAM) 106, a controller 108, and one or more storage components such as non-volatile memory devices 110a-110n (referred to herein as the memory device(s) 110). RAM 106 may be, for example, static RAM (SRAM) or dynamic RAM (DRAM) that be used to temporarily store data on storage device 104. For example, RAM 106 may store portions of a logical-to-physical (L2P) table that may be used to map a logical block address (LBA) in a host command to a physical address on memory device 110.

Controllers 108 may interface with host 102 and process foreground operations including instructions transmitted from host 102. For example, controllers 108 may read data from and/or write to memory devices 110 based on instructions received from host 102. Controllers 108 may also execute background operations to manage resources on memory device 110. For example, controllers 108 may monitor memory devices 110 and may execute garbage collection and other relocation functions per internal relocation algorithms to refresh, recycle, and/or relocate the data on memory devices 110.

Memory devices 110 may be flash based. For example, memory devices 110 may be a NAND or NOR flash memory that may be used for storing host and control data over the operational life of memory devices 110. Memory devices 110 may include one or more dies (i.e., DIE 1-DIE N) connected to a memory bus including data lines and chip enable lines. Memory devices 110 may save data in blocks in various formats, with the formats being defined by the number of bits that may be stored per memory cell. For example, a single-level cell (SLC) format may write one bit per memory cell, a multi-level cell (MLC) format may write two bits per memory cell, a triple-level cell (TLC) format may write three bits per memory cell, a quadruple-level cell (QLC) format may write four bits per memory cell, and so on. A format used to store fewer bits per memory cell may be accessed faster than a format used to store more bits per memory cell. As such, during peak performance when storage device 104 is performing a burst write operation, controller 108 may write data to SLC blocks. During normal/sustained write operations on storage device, controller 108 may write data to blocks that may store more bits per cell than SLC blocks including, for example, MLC, TLC, and/or QLC blocks. Memory device 110 may be included in storage device 104 or may be otherwise communicatively coupled to storage device 104.

When host 102 transmits a command to storage device 104, controller 108 may receive the command and determine if the command is, for example, a write command, a read command, or an administration command. If the command received from host 102 is a write command, controller 108 may perform stream classification and determine if the data is to be written to memory device 110 in a sequential format or in a random format. Host data written in the sequential format (referred to herein as sequential host data) may be stored in contiguous blocks in memory device 110 and host data written in the random format (referred to herein as random host data) may be stored in contiguous and/or non-contiguous blocks in memory device 110.

Controller 108 may also perform chunking on the host data and may break up or accumulate the host data into uniform-sized chunks before sending the data to memory device 110. Exemplary chunk sizes may be 4 kilobytes (K), 8K, 16K, 32K bytes, etc. In an example where controller 108 breaks up or accumulates the host data into 4 KB chunks, when controller 108 receives a write command with 512 KB data from host 102, controller 108 may break up the 512 KB data into 128 4-KB chunks. If the size of the host data is smaller than 4 KB, controller 108 may accumulate the host data, before sending the data to memory device 110, until the data size reaches 4 KB.

After performing stream classification and chunking, controller 108 may identify a pattern of random and/or sequential host data (referred to herein as host data pattern) in a host data stream. For example, controller 108 may identify the host data pattern to be 128K of sequential data followed by five random write requests of 4K chunks. Controller 108 may send a message for the host data to a flash translation layer (FTL) 112 which may determine how the host data may be routed and stored on memory device 110. Controller 108 may map LBAs in the host data to the physical locations in memory device 110 where the host data may be stored and manage the logical-to-physical mappings. In carrying out host write operations, controller 108 may also perform control write operations, wherein controller 108 may write control data such as logical-to-physical data to a global address table (GAT). When host 102 wants to read data from memory device 110, host 102 may send the LBA(s) associated with the data to storage device 104 and, based on the logical-to-physical mappings, controller 108 may retrieve the data from memory device 110.

Controller 108 may dynamically evaluate the current usage of storage device 104 and/or memory device 110 to determine current values for performance benchmarks such as endurance, write amplification factor (WAF), performance, power, etc. on storage device 104 and/or memory device 110. Controller 108 may periodically analyze a data pattern in the host data stream. For example, controller 108 may periodically analyze one or more host data streams and determine that the host data stream(s) includes 128K of sequential data followed by five random write requests of 4K chunks. Controller 108 may also dynamically evaluate the routing overheads associated with a host data stream to determine the effective performance benchmarks for WAF, endurance, performance of storage device 104, etc. for the host data stream. The routing overheads may include overhead associated with the intermediate caching of a block until the data is stored in a destination block on memory device 110, the amount of data-padding involved during storage for the underlying FTL architecture used on storage device 104, the amount of sector padding during logical alignment, and/or the amount of control writes associated with the data.

In analyzing current/ongoing host data stream(s), controller 108 may accumulate the host write commands received on storage device 104 (for example, the LBA(s) and chunk size). Controller 108 may store the total written data sent from host 102 to storage device 104 (for example, ∑ LBA1 +…LBA n-1). Controller 108 may read the current program-erase cycle of storage device 104 and obtain the actual data written to memory device 110, wherein the actual data written may be equal to the capacity of storage device 104 multiplied by the program-erase cycle. Controller 108 may calculate the WAF to be equal to the actual data written divided by the host data written, calculate the performance of storage device 104 based on an internal time on memory device 110 and WAF, and obtain the a power value from storage device 104 to identify the power being used by storage device in processing the current host data stream.

Controller 108 may also evaluate one or more other possible host data patterns and expected behavior of storage device 104 based on historical host data patterns. Controller 108 may calculate the performance benchmark values for the other host data pattern(s). For example, controller 108 may identify the current host data pattern and health status of storage device 104 and/or memory device 110, calculate an ideal performance of memory device 110, and/or calculate the performance of storage device 104 and/or memory device 110 based on the other possible host data pattern(s) (for example, different chuck sizes and NAND interleave (for example, different patterns of random and sequential host data)). Controller 108 may analyze the current host data stream as per the current host data pattern and the benchmark parameters such as WAF, power, endurance, sustained performance, life expectancy in terms of current host speed, etc. associated with the current host data stream. Controller 108 may re-evaluate one or more new data patterns using the other possible host data patterns as per an FTL algorithm, wherein controller 108 may obtain benchmark parameters such as the WAF, power, performance, etc. associated with the other possible host data patterns. Controller 108 may record the benchmark values for the other possible host data patterns in a benchmark table.

Consider an example where controller 108 determines that the current host data stream includes 128K of sequential data followed by five random write requests of 4K chunks. Controller 108 may calculate a WAF to be equal to 2.6 and determine that the host power used by storage device 104 may be approximately 0.2Watts (W). Based on the current host data pattern and health status of storage device 104 and/or memory device 110, controller 108 may also identify other possible host data patterns and expected behavior of storage device 104. Controller 108 may dynamically evaluate the WAF for the other possible host data patterns based on one or more FTL parameters including, for example, determining (a) that larger command sizes may be routed directly to TLC memory in direct write solutions, resulting in lower WAF, otherwise the WAF may be higher with more SLC folding; (b) that cold data indication may be routed directly to TLC memory in direct write solutions, resulting in lower WAF, otherwise the WAF may be higher with more SLC folding; (c) that random data (for example, 4KB chunks) may have a specific WAF as determined by storage device 104 and the random data may have the most control update overheads; (d) that sequential data that is larger than a size threshold may have the least WAF that may result in direct write into the TLC memory, resulting in least the padding and control updates;(e) that write sizes aligned with logical pages may be efficient and may not have padding, resulting in lower WAF; and/or (f) that unaligned writes may have increased WAF. For example, controller 108 may identify other possible host data patterns of 512K of sequential data followed by five random write requests of 4K chunks wherein the WAF may be 1.8 and one megabyte (MB) of sequential data followed by five random write requests of 4K chunks wherein the WAF may be 1.3.

Controller 108 may record the benchmark values for the current host data stream and other possible host data patterns in the benchmark table/database. Controller 108 may recommend the other possible host data patterns to host 102. Host 102 may use the information in the benchmark table to determine if host data streams should be modified to improve performance on storage device 104 and/or increase the life expectancy of storage device 104. For example, host 102 may use the information in the benchmark table to determine if the chuck size and/or host data pattern for a host data stream should be modified to optimize the WAF, align the command sectors at 4K boundary rather than unaligned requests, switch to a specific input/output (IO) command size, and/or tweak the storage driver parameters to suit the WAF requirement wherever its architecture allows dynamic requests dealing with storage device 104.

Controller 108 may also track and characterize the behavior of memory device 110 to determine an effective WAF for data being analyzed. For example, if during a given period controller 108 determines that the NAND block failure rate is higher than an expected threshold, controller 108 may proportionately increase the WAF ratio in the benchmark table (to be sent to host 102) to compensate for the loss of logical blocks. Controller 108 may also determine a set of possible WAF for a set of possible host data patterns, record the WAF for each possible host data pattern in the benchmark table, and provide the benchmark table including WAF ratios for various host data patterns to host 102 such that host 102 may use a possible host data pattern to minimize the overall WAF on storage device 104.

In an implementation, storage device 104 may periodically receive a polling request, for example, a read request from host 102 for the benchmark table. When host 102 periodically polls storage device 104 with the read request for the benchmark table, storage device 104 may evaluate the current host data stream and/or possible host data patterns in the background, which may increase the power used by storage device 104. Storage device 104 may provide values for benchmarks such as endurance, write amplification factor (WAF), performance, power, etc. associated with the current host data stream and/or possible host data patterns to host 102. Host 102 may use a recommended host data pattern to, for example, improve the performance on storage device 104 and/or the life expectancy of storage device 104.

In an implementation, storage device 104 may receive a targeted request from host 102. The targeted request may be a request to storage device 104 for a recommendation of one or more new host data patterns. Storage device 104 may execute the targeted request without considering its current performance and/or the power being consumed by storage device 104. Storage device 104 may provide values for benchmarks such as endurance, write amplification factor (WAF), performance, power, etc. associated with the possible/recommended host data patterns to host 102. Host 102 may dynamically change a host data stream being sent to storage device 104 based on recommendations from storage device 104 to improve the performance of storage device 104. For example, host 102 may dynamically switch from a first host application to a second host application that may submit a host data stream based on recommendations from storage device 104.

In implementation, storage device 104 may also receive a pattern analysis request wherein host 102 may send host data pattern details in which host 102 may request analysis of one or more benchmark parameters based on specific host parameters, such as a specific chuck size and/or host data pattern. Based on the pattern analysis request, controller 108 may obtain the benchmark parameters on storage device 104 and/or memory device 110 including WAF, power, endurance, performance of storage device 104 and/or memory device, etc. Storage device 104 may send benchmark parameters to host 102 and host 102 may use the benchmark parameters to improve performance on storage device 104.

Consider an example, where host 102 is a surveillance host system. Host 102 may provide a set of host data patterns to storage device 104. Controller 108 may analyze the set of host data patterns and send benchmark parameters associated with the set of host data patterns to host 102. Host 102 may use benchmark parameters to determine an efficient pattern (for example, command sizes to minimize TLC padding in a direct write storage architecture) for storing data on memory device 110 to ensure that the WAF is minimized.

Host 102 may additionally coalesce data and the associated metadata prior to storing them in memory device 110 when host 102 determines that the accumulated length saves WAF in storage device 104 based on the received WAF ratios. As an example, host 102 may coalesce the metadata to the data as one logical entity (logically sequential to one another) to align the overall size as per storage device 104 WAF table expectations to improve the life of the storage device 104 for the same dataset.

Storage device 104 may perform these processes based on one or more processors, for example, controller 108 (and other components on storage device 104 including FLT 112) executing software instructions stored by a non-transitory computer-readable medium, such as a storage component that may be, for example, memory device 110. As used herein, the term “computer-readable medium” refers to a non-transitory memory device. Software instructions may be read into the storage component from another computer-readable medium or from another device. When executed, software instructions stored in the storage component may cause one or more processors, for example, controller 108 (and other components on storage device 104 including FLT 112) to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

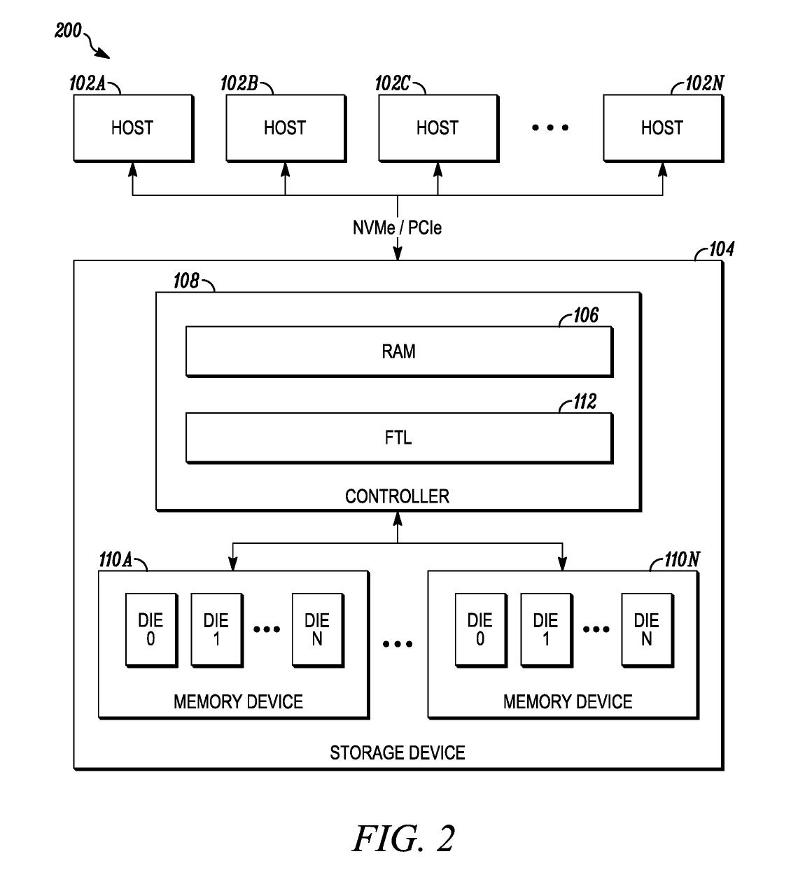

FIG. 2 is another block diagram of an example system in accordance with some implementations. System 200 may include multiple hosts 102a-102n communicatively coupled to storage device 104. Controller 108 may periodically analyze multiple host data streams, wherein a first host data stream may be associated with a first host (for example, host 102a), a second host data stream may be associated with a second host (for example, host 102b), a third host data stream may be associated with a third host (for example, host 102c), and so on. Controller 108 may dynamically evaluate the current usage of storage device 104 and/or memory device 110 while storage device 104 is receiving the multiple host data streams. Based on the current usage of storage device 104 and/or memory device 110, controller 108 may determine ongoing values for benchmarks such as endurance, write amplification factor (WAF), performance, power, etc. on storage device 104 and/or memory device 110. For example, controller 108 may perform WAF analysis for the multiple host data streams.

Based on the current host data stream and health status of storage device 104 and/or memory device 110, controller 108 may also identify other possible host data patterns and expected behavior of storage device 104. Controller 108 may record the benchmark values for each host data stream in one or more benchmark tables and may manage the benchmark table(s). For example, controller 108 may identify other possible host data patterns and associated benchmark values for the first host data stream and controller 108 may store the other possible host data patterns and associated benchmark values in a first benchmark table, controller 108 may identify other possible host data patterns and associated benchmark values for the second host data stream and controller 108 may store the other possible host data patterns and associated benchmark values in a second benchmark table, controller 108 may identify other possible host data patterns and associated benchmark values for the third host data stream and controller 108 may store the other possible host data patterns and associated benchmark values in a third benchmark table, and so on.

Controller 108 may use benchmark values in one or more benchmark tables to identify a host with a benchmark value that is greater than a threshold. For example, controller may use WAF values in one or more benchmark tables to identify a host with a WAF value that is greater than a threshold. Storage device 104 may inform the host with a benchmark value that is greater than a threshold of the effect of the host data stream on storage device 104. For example, if the WAF for host 102b is greater than the threshold, storage device 104 may inform host 102b of the effect of the second host data stream on storage device 104. Storage device 104 may provide information (for example, current and/or possible host data patterns and associated benchmark values) in the benchmark table associated with host 102b to host 102b.

Host 102b may use the information in the benchmark table to determine if parameters for the second host data stream should be modified to improve performance on storage device 104 and/or increase the life expectancy of storage device 104. For example, host 102b may use the information in the benchmark table to determine if the chuck size and/or host data pattern in the second host data stream should be modified to optimize the WAF, align the command sectors at 4K boundary rather than unaligned requests, switch to a specific IO command size, and/or tweak the storage driver parameters to suit the WAF requirement wherever its architecture allows dynamic requests dealing with the storage device.

If, for example, host 102b determines based on the information in the benchmark table that the second host data stream is being generated by a first host application running on host 102b and that the second host data stream is associated with a WAF value that is greater than a threshold, host 102b may obtain a recommendation with a new host data pattern from the benchmark table. Host 102b may use the recommendation to determine whether to switch from the first host application to a second host application which may cause the second host data stream to have a WAF that is less than the threshold. FIG. 2 is provided as an example. Other examples may differ from what is described in FIG. 2.

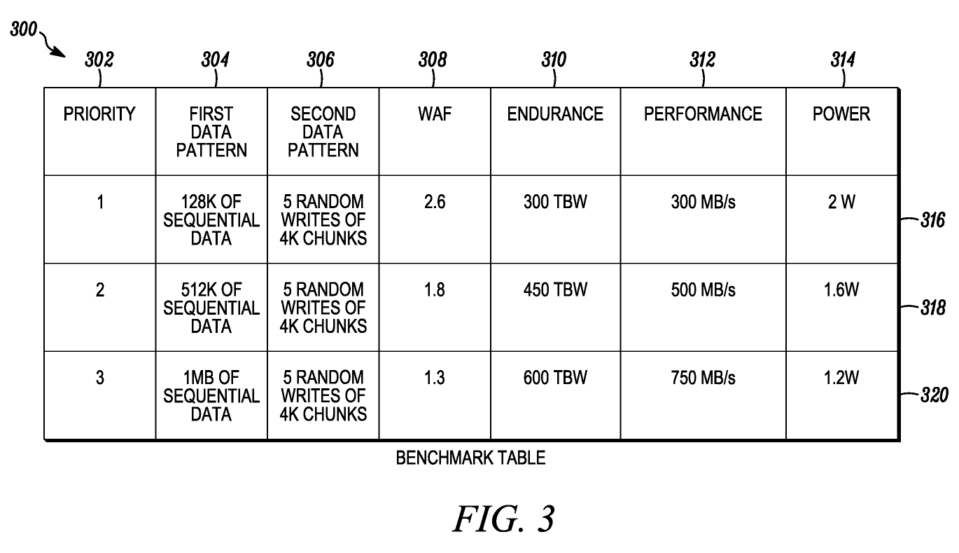

FIG. 3 is an example benchmark table used in accordance with some implementations. The entries in table 300 may include a priority field 302, a first data pattern field 304, a second data pattern field 306, a WAF field 308, an endurance field 310, a performance field 312, and a power field 314. Priority field 302 may rank recommendations from storage device 104 based on the values of one or more benchmark parameters in table 300. Information for a current host data stream may be in the first entry 316 and may have a priority of one. Information for other possible host data patterns may be in the other entries in table 300, wherein priority field 302 may be used to rank recommendations of other possible host data patterns based on the values of one or more benchmark parameters in table 300.

In an example where the current host data stream includes 128K of sequential data followed by five random write requests of 4K chunks and controller 108 calculates a WAF to be equal to 2.6 and determines that the endurance, performance and host power used by storage device 104 is approximately 300 terabytes written (TBW), 300 megabits per second (MB/s), and 0.2Watts (W), first entry 316 may include the information associated with the current host data stream. The other entries 318 and 320 may include information for other possible host data patterns. Table 300 may include any number of entries. The information shown on table 300 is only provided as an example. FIG. 3 is provided as an example. Other examples may differ from what is described in FIG. 3.

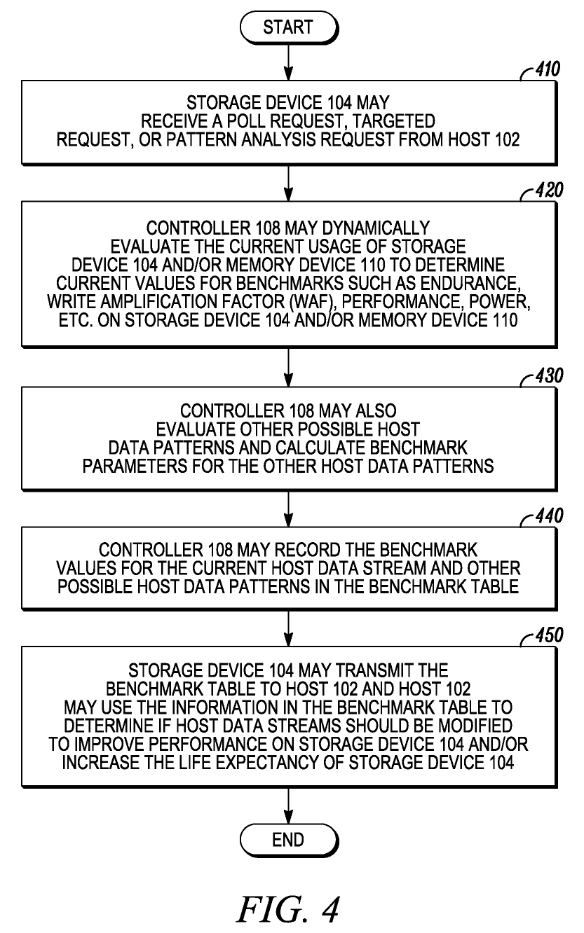

FIG. 4 is an example flow diagram for providing run time recommendations for host data streams in accordance with some implementations. At 410, storage device 104 may receive a poll request, targeted request, or pattern analysis request from host 102. At 420, controller 108 may dynamically evaluate the current usage of storage device 104 and/or memory device 110 to determine current values for benchmarks such as endurance, write amplification factor (WAF), performance, power, etc. on storage device 104 and/or memory device 110. At 430, controller 108 may also evaluate other possible host data patterns and calculate benchmark parameters for the other host data patterns. At 440, controller 108 may record the benchmark values for the current host data stream and other possible host data patterns in the benchmark table. At 450, storage device 104 may transmit the benchmark table to host 102 and host 102 may use the information in the benchmark table to determine if host data streams should be modified to improve performance on storage device 104 and/or increase the life expectancy of storage device 104. As indicated above FIG. 4 is provided as an example. Other examples may differ from what is described in FIG. 4.

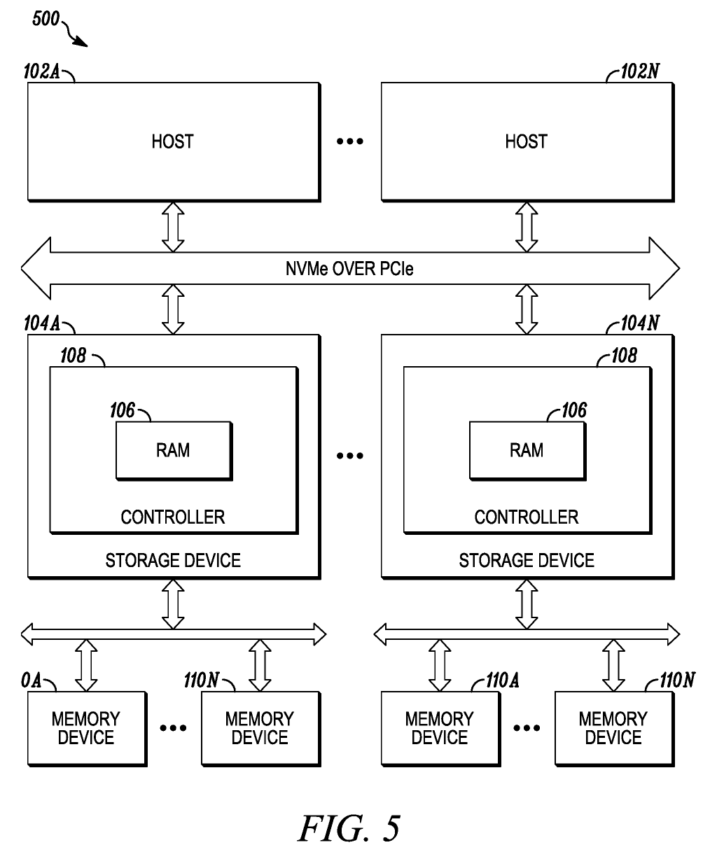

FIG. 5 is a diagram of an example environment in which systems and/or methods described herein are implemented. As shown in FIG. 5, Environment 500 may include hosts 102-102n (referred to herein as host(s) 102), and one or more storage devices 104a-104n (referred to herein as storage device(s) 104). Controller 108 may provide run time recommendations for host(s) data streams to improve the performance of storage device 104. Hosts 102 and storage devices 104 may communicate via Non-Volatile Memory Express (NVMe) over peripheral component interconnect express (PCI Express or PCIe), SD, or the like.

Devices of Environment 500 may interconnect via wired connections, wireless connections, or a combination of wired and wireless connections. For example, the network in FIG. 5 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of Environment 500 may perform one or more functions described as being performed by another set of devices of Environment 500.

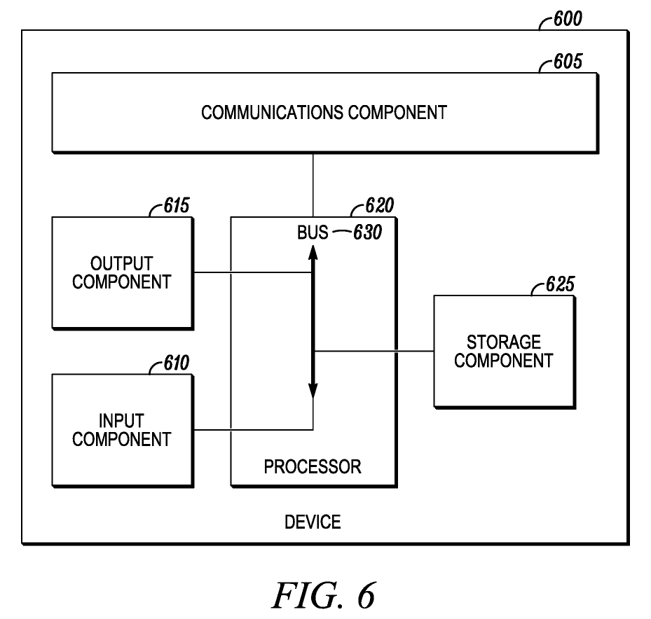

FIG. 6 is a diagram of example components of one or more devices of FIG. 1. In some implementations, host 102 may include one or more devices 600 and/or one or more components of device 600. Device 600 may include, for example, a communications component 605, an input component 610, an output component 615, a processor 620, a storage component 625, and a bus 630. Bus 630 may include components that enable communication among multiple components of device 600, wherein components of device 600 may be coupled to be in communication with other components of device 600 via bus 630.

Input component 610 may include components that permit device 600 to receive information via user input (e.g., keypad, a keyboard, a mouse, a pointing device, and a network/ data connection port, or the like), and/or components that permit device 600 to determine the location or other sensor information (e.g., an accelerometer, a gyroscope, an actuator, another type of positional or environmental sensor). Output component 615 may include components that provide output information from device 600 (e.g., a speaker, display screen, and network/ data connection port, or the like). Input component 610 and output component 615 may also be coupled to be in communication with processor 620.

Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 may include one or more processors capable of being programmed to perform a function. Processor 620 may be implemented in hardware, firmware, and/or a combination of hardware and software.

Storage component 625 may include one or more memory devices, such as random-access memory, read-only memory (ROM), and/or another type of dynamic or static storage device (e.g., a flash memory, a magnetic memory, and/or optical memory) that stores information and/or instructions for use by processor 620. A memory device may include memory space within a single physical storage device or memory space spread across multiple physical storage devices. Storage component 625 may also store information and/or software related to the operation and use of device 600. For example, storage component 625 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 605 may include a transceiver-like component that enables device 600 to communicate with other devices, such as via a wired connection, a wireless connection, or a combination of wired and wireless connections. The communications component 605 may permit device 600 to receive information from another device and/or provide information to another device. For example, communications component 605 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 605 may also include one or more broadband and/or narrowband transceivers and/or other similar types of wireless transceiver configurable to communicate via a wireless network for infrastructure communications. Communications component 605 may also include one or more local area network or personal area network transceivers, such as a Wi-Fi transceiver or a Bluetooth transceiver.

Device 600 may perform one or more processes described herein. For example, device 600 may perform these processes based on processor 620 executing software instructions stored by a non-transitory computer-readable medium, such as storage component 625. As used herein, the term “computer-readable medium” refers to a non-transitory memory device. Software instructions may be read into storage component 625 from another computer-readable medium or from another device via communications component 605. When executed, software instructions stored in storage component 625 may cause processor 620 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, or “contains …a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to provide run-time recommendations to a host for the host to modify host data streams being sent to the storage device to improve performance on the storage device, the storage device comprises:
a memory device to store host data sent from the host to the storage device; and
a controller to receive a host data stream, analyze the host data stream and identify a first performance benchmark value associated with the host data stream, evaluate a possible host data pattern and calculate a second performance benchmark value for the possible host data pattern, and provide at least one of the first performance benchmark value and the second performance benchmark value to the host.

2. The storage device of claim 1, wherein the controller periodically analyses a data pattern in the host data stream and evaluates routing overheads associated with the host data stream to determine an effective performance benchmark value for the host data stream.

3. The storage device of claim 1, wherein in analyzing the host data stream, the controller accumulates host write commands received on the storage device, stores total written data sent from the host to the storage device, reads a current program-erase cycle of the storage device, obtains actual data written to the memory device, and calculates a write amplification factor and storage device performance.

4. The storage device of claim 3, wherein the write amplification factor is equal to actual data written divided by host data written on the memory device and the storage device performance is based on an internal time on the memory device and the write amplification factor.

5. The storage device of claim 1, wherein in analyzing the host data stream, the controller obtains a value for power being used on the storage device in processing the host data stream.

6. The storage device of claim 1, wherein in evaluating the possible host data pattern, the controller identifies a current host data pattern and health status of the storage device, calculates an ideal performance of the memory device, calculates performance of the storage device based on the possible host data pattern, analyzes the host data stream as per the current host data pattern and benchmark parameters associated with the host data stream, reevaluates a new data pattern using the possible host data pattern, and obtains performance benchmark values for the possible host data pattern.

7. The storage device of claim 1, wherein the controller stores the first performance benchmark value and the second performance benchmark value in a benchmark database.

8. The storage device of claim 1, wherein the controller recommends the possible host data pattern to the host for the host to determine if the host data stream is to be modified to improve the performance on the storage device.

9. The storage device of claim 1, wherein the controller characterizes behavior of the memory device to determine an effective write amplification factor for data being analyzed.

10. The storage device of claim 1, wherein the storage device receives a periodic poll request from the host and the controller evaluates the host data stream and the possible host data pattern in response to the periodic poll request.

11. The storage device of claim 1, wherein the storage device receives a targeted request from the host, the targeted request being a request for a recommendation for a new host data pattern, and the controller evaluates the possible host data pattern in response to the targeted request.

12. The storage device of claim 1, wherein the storage device receives a pattern analysis request including host data pattern details from the host and the controller analyzes a performance benchmark parameter based on a host parameter, obtains performance benchmark values associated with the host data pattern details, and sends the performance benchmark values associated with the host data pattern details to the host.

13. A storage device to provide run-time recommendations to multiple hosts for the hosts to modify host data streams being sent to the storage device to improve performance on the storage device, the storage device comprises:
a memory device to store host data sent from the host to the storage device; and
a controller to
receive a first host data stream from a first host and a second host data stream from a second host,
analyze the first host data stream and identify a first performance benchmark value that is associated with the first host data stream and analyze the second host data stream and identify a second performance benchmark value that is associated with the second host data stream,
evaluate a first possible host data pattern for the first host and determine a first benchmark value for the first possible host data pattern,
evaluate a second possible host data pattern for the second host and determine a second benchmark value for the second possible host data pattern,
determine when at least one of the first benchmark value and the second benchmark value is greater than a threshold and provide an indication to at least one for the first host and the second host with a benchmark value that is greater than the threshold.

14. A method on a storage device for providing run-time recommendations to a host for the host to modify host data streams being sent to the storage device to improve performance on the storage device, the storage device comprises a controller to execute the method comprising: receiving a host data stream;
analyzing the host data stream and identifying a first performance benchmark value that is associated with the host data stream;
evaluating a possible host data pattern and calculating a second performance benchmark value for the possible host data pattern; and
providing at least one of the first performance benchmark value and the second performance benchmark value to the host.

15. The method of claim 14, wherein in analyzing the host data stream, the method further comprises:
accumulating host write commands received on the storage device,
storing total written data sent from the host to the storage device,
reading a current program-erase cycle of the storage device,
obtaining actual data written to a memory device, and
calculating a write amplification factor and storage device performance.

16. The method of claim 14, wherein in analyzing the host data stream, the method further comprises obtaining a power value for power being used on the storage device in processing the host data stream.

17. The method of claim 14, wherein in evaluating the possible host data pattern, the method further comprises:
identifying a current host data pattern and health status of the storage device, calculating an ideal performance of a memory device,
calculating performance of the storage device based on the possible host data pattern,
analyzing the host data stream as per the current host data pattern and benchmark parameters associated with the host data stream,
reevaluating a new data pattern using the possible host data pattern, and
obtaining performance benchmark values for the possible host data pattern.

18. The method of claim 14, further comprising storing the first performance benchmark value and the second performance benchmark value in a benchmark database.

19. The method of claim 14, further comprising recommending the possible host data pattern to the host for the host to determine if the host data stream is to be modified to improve the performance on the storage device.

20. The method of claim 14, further comprising tracking and characterizing behavior of a memory device to determine an effective write amplification factor for data being analyzed.
